(19) United States
(12) Patent Application Publication
(10) Pub. No.: US 2006/0191102 A1
(43) Pub. Date: Aug. 31, 2006

(54) Color-coded stainless steel fittings and ferrules

(76) Inventors: Charles W. Hayes II, Wickliffe, OH (US); Peter Ehlers, Cleveland Heights, OH (US); Peter C. Williams, Cleveland Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/272,915

(22) Filed: Nov. 14, 2005

Related U.S. Application Data
(60) Provisional application No. 60/653,147, filed on Feb. 15, 2005.

(51) Int. Cl. F16L 11/10

(52) U.S. Cl. 16/108

(57) ABSTRACT

A stainless steel tube fittings, or components thereof, are color coded by providing an oxide coating of a different color on one or more of its surfaces, the colored oxide coating having a thickness of ≦1000 [symbol] .

### CROSS REFERENCE TO RELATED APPLICATION

This application is based on Provisional Application 60/653,147, filed Feb. 15, 2005, the benefit of which is hereby claimed.

### BACKGROUND AND SUMMARY

U.S. Pat. No. 5,573,529 describes a process for color coding stainless steel medical instruments in which a colored water-borne polyurethane coating is electrodeposited onto the “non-invasive” portions of the instrument and then cured. The coatings so formed are said to be easy to see in normal light yet strong enough to withstand repeated handling and autoclave sterilization. They represent a considerable improvement over then-existing technology for color coding metal articles which, according to patentees, produce coatings that are difficult to see in normal light, prone to flaking after repeated autoclaving and/or are so thick they adversely affect device functionality. Note in particular the extensive discussion in the Background section of this patent of various prior art approaches for color coding metal articles and the disadvantages of each.

In another technique for color coding metal articles, which is mentioned in the above-noted '529 patent and described in detail in U.S. Pat. No. 5,275,612, plastic ferrules of different colors are used to signify different types of laparoscopic medical instruments.

In still another technique for color coding metal articles, as described in U.S. Pat. No. 5,062,173, the individual stainless steel blades or tools of a multi-function tool in the nature of a “Swiss Army knife” are color coded “by coating with colored ‘TEFLON’ . . . or by electroplating.” However, details of these coloring processes are not described.

The techniques described in these patents are regarded as ineffective for coloring stainless steel tube fittings and ferrules where the fitting, ferrule and/or tube being joined undergoes minor but not insignificant deformation as a result of the substantial stresses that are created during “pull-up” (i.e., final tightening) of the fitting. This is because conventionally-prepared color coatings of the type described in these patents may degrade as a result of the stresses encountered in this environment. In addition, such coatings may also change the dynamic response of the fitting/ferrule combination in response to applied stress, thereby adversely affecting fitting performance.

In particular, the conduit-gripping ferrules used in most conduit fittings perform a variety of different functions depending on the particular type of fitting in which they are used. For example, some ferrules have leading or “cutting” edges which cut or “bite” into the conduit being joined during pull-up. In other fittings, the ferrule undergoes significant plastic deformation during sealing. In still other fitting designs, a ferrule may do both. See, commonly assigned Application Serial No. US60/652,631 (attorney docket no. 22188/06884), the disclosure of which is incorporated herein by reference. Paints, polymers or other plastic articles which are used to indicate color are regarded as unacceptable for these applications, since these materials are likely to deform and/or delaminate during pull-up due to the substantial stresses involved.

U.S. Pat. No. 4,026,737, U.S. Pat. No. 4,269,633, U.S. Pat. No. 4,859,287 and U.S. Pat. No. 4,620,882 describe coloring processes for making large-area architectural structural elements such as builiding panels and the like in which continuous sheets of stainless steel are immersed in aqueous baths containing chromic and sulfuric acids, optionally with the application of electrical potential. Depending on the conditions employed, oxide films of different colors are developed. However, the object of these processes is to achieve color uniformity in the same and subsequent workpieces. That is, the object is to produce large area architectural workpieces have uniform color tones over their entire surface areas, and to reproduce this same color tone repeatedly and exactly from workpiece to workpiece. Color coding for identification purposes is not involved. Moreover as in the case of the color coding technology discussed above, this coloring technology is not intended for use on objects whose colored portions are subjected to substantial deformation stresses in use.

In accordance with the invention, stainless steel tube fittings are color coded for facilitating easy identification by growing a colored oxide film on one or more surfaces of the fitting (or its component parts) electrochemically or thermally, the colored oxide film having a thickness of ≦1000 [symbol] (i.e., ≦100 Nm), preferably ≦500 [symbol] (i.e., ≦50 Nm). With this approach, it has been found that the applied oxide layer is thin enough and adherent enough that is not only can withstand the applied stress without significant degradation but also exerts essentially no adverse effect on the performance of the fitting.

### DETAILED DESCRIPTION

Tube Fittings and Ferrules

Tube fittings are well known articles of commerce which are described, for example, in commonly assigned application Serial No. US60/652,631 (attorney docket no. 22188/06884), the disclosure of which is incorporated herein by reference. Typically, a fitting is composed of various components including body sections, nuts, ferrules or “gripping rings,” and the like. Moreover as described in Ser. No. US60/652,631, a ferrule may be designed so that, during pull-up, it plastically deforms, or its leading edge bites into the conduit being joined, or both. In accordance with this invention, such fittings (and/or component parts thereof) are color coded for easy identification by growing a colored oxide coating on one or more surfaces of the fitting or part thereof.

Although tube fittings can be made from a wide variety of different metals, fittings of particular interest are made from steels containing 5 to 50, preferably 10 to 40, wt. % Ni. Preferred alloys contain 10 to 40 wt. % Ni and 10 to 35 wt. % Cr. More preferred are the stainless steels, especially the AISI 300 and 400 series steels. Of special interest are AISI 316, 316L, 317, 317L and 304 stainless steels, alloy 600, alloy C-276 and alloy 20 Cb, to name a few examples. Fittings made from such steels, and particularly from austenitic stainless steels, find particular use in high purity piping systems, i.e., piping systems used for processing high purity liquids and gases. See, also, U.S. Pat. No. 6,547,888 B1, the disclosure of which is also incorporated by reference.

Colored Oxide Coatings

As is well known, stainless steel is stainless because chromium metal in the steel oxidizes from contact with air, thereby forming a thin, coherent (impervious) layer of chromium oxide, approximately 20 [symbol] thick. For convenience, this chromium oxide coating will be referred to as the “native” chromium oxide coating. In accordance with the invention, oxide coatings of different colors are formed on the surfaces of such stainless steel fittings and/or component parts thereof to help in identifying such products in different styles, sizes, etc. In this context, “coatings of different colors” will be understood to mean not only that the colors of the coatings are different from one another but also different from the native chromium oxide coating.

Colored oxide coatings can be produced in a variety of different ways in accordance with this invention. In accordance with one technique, colored oxide coatings are grown by heating the stainless steel workpiece at elevated temperatures for extended periods of time in the presence of an oxygen-containing gas such as air. This will cause additional amounts of chromium in the steel to oxide, thereby increasing the thickness of the coherent chromium oxide coating on the workpiece surfaces. Oxide coatings formed in this way exhibit different colors, depending on coating thickness. Therefore it is possible to produce fittings and fitting components of various different colors by choosing appropriate times and temperatures for the heat treatment. Additional colorants such as dyes and/or pigments can also be impregnated into such oxide coatings, typically by means of an organic solvent or other vehicle, since these coatings exhibit at least some porosity.

Another approach for producing colored oxide coatings is to electroplate the fitting or component with chromium metal or an alloy containing chromium metal. As soon as such an electroplated workpiece is exposed to an oxygen-containing gas such as sir the chromium will oxidize. This produces an additional coherent chromium oxide coating, i.e., a chromium oxide coating over and above the native chromium oxide coating on the stainless steel article (it being understood that these two chromium oxide coatings may merge into one). Since chromium oxide coatings made in this way are inherently porous at least to some degree, different colors can be introduced into such coatings by impregnation with a colorant such as a dye or pigment, for example, typically contained in an organic solvent or other suitable vehicle.

Regardless of which technique is used to produce the colored oxide coating, it should be thick enough to allow the desired color to be imparted thereto, but not so thick that it will adversely affect the functioning of the fitting or its component parts. Thus, the colored oxide coating will normally be typically at least about 50 [symbol] thick but no greater than about 1000 [symbol] thick. Thicknesses on the order of about 75 to 750 [symbol] , and more especially 100 to 500 [symbol] , are of special interest, as are thicknesses of about 200 to 400 [symbol] and even 250 to 350 [symbol] .

Carburized Workpieces

In commonly assigned U.S. Pat. No. 6,547,888 B1 mentioned above, there are described a number of different techniques for increasing the hardness of articles made from austenitic stainless steels by low temperature carburization, i.e., carburization carried out in such a way that a hardened surface or “case” rich in diffused carbon but substantially free of carbide precipitates is formed. The technology of this invention can be used to produce colored oxide coatings on fittings, including component parts thereof, which have been low temperature carburized by any such low temperature carburization technique.

In commonly assigned application Serial No. US60/652,631 (attorney docket no. 22188/06884) mentioned above, there is described a technique for enhancing the performance of various different types of tube fittings and couplings by applying a lubricant thereto. Other techniques for applying lubricants to stainless steel articles in general are known. All such techniques can be used in combination with the technology of this invention. That is to say, fittings and fitting components which have been provided with a colored oxide coating in accordance with this invention can be lubricated by any of these technologies.

1. A color coded stainless steel tube fitting, or a component part of such a fitting, the fitting or component being treated so as to impart a part-identifying color to one or more of its surfaces which is different from the color of the fitting or component absent the treatment, the part-identifying color being formed from a colored oxide coating having a thickness of ≦1000 [symbol] .

2. The fitting or component of claim 1, wherein the fitting or component is a ferrule.

3. The fitting or component of claim 2, wherein the stainless steel tube fitting is designed for joining to a conduit, wherein the ferrule defines a leading edge, and wherein
the ferrule is designed so that this leading edge bites into the conduit during pull-up, or
the ferrule is designed to undergo plastic deformation during pull-up, or
both.

4. The fitting or component of claim 1, wherein the colored oxide coating is produced electrochemically or thermally.

5. The fitting or component of claim 1, wherein the fitting or component has been low temperature carburized before application of the colored oxide coating.

6. The fitting or component of claim 5, wherein the fitting or component is a ferrule.

7. The fitting or component of claim 6, wherein the stainless steel tube fitting is designed for joining to a conduit, wherein the ferrule defines a leading edge, and wherein
the ferrule is designed so that this leading edge bites into the conduit during pull-up, or
the ferrule is designed to undergo plastic deformation during pull-up, or
both.

8. The fitting or component of claim 7, wherein the colored oxide coating is produced electrochemically or thermally.

9. The fitting or component of claim 5, wherein a lubricant is applied to the surfaces of the fitting or component having an oxide coating of a different color thereon.

10. The fitting or component of claim 9, wherein the fitting or component having an oxide coating of a different color on one or more of its surfaces is a ferrule.

11. The fitting or component of claim 10, wherein the stainless steel tube fitting is designed for joining to a conduit, wherein the ferrule defines a leading edge, and wherein
the ferrule is designed so that this leading edge bites into the conduit during pull-up, or
the ferrule is designed to undergo plastic deformation during pull-up, or
both.

12. The fitting or component of claim 1, wherein the thickness of the colored oxide coating is about 50 [symbol] thick but no greater than about 1000 [symbol] thick.

13. A method for facilitating identification of different styles or sizes of stainless steel tube fittings, or component parts of such fittings, comprising forming oxide coatings of different colors on one or more surfaces of the different fittings or components, the colored oxide coatings having thicknesses of ≦000 [symbol] .

14. The method of claim 13, wherein the oxide coatings of different color are produced electrochemically or thermally.

15. The method of claim 13, wherein the fittings or components having oxide coatings of different colors are ferrules.

16. The method of claim 15, wherein the stainless steel tube fittings are designed for joining to a conduit, wherein the ferrules define leading edges, and wherein
the ferrules are designed so that these leading edges bite into the conduit during pull-up, or
the ferrules are designed to undergo plastic deformation during pull-up, or
both.

17. The method of claim 13, wherein the fittings or components have been low temperature carburized before application of the colored oxide coatings.

18. The method of claim 17, wherein the fittings or components having oxide coatings of different colors are ferrules.

19. The method of claim 18, wherein the stainless steel tube fittings are designed for joining to a conduit, wherein the ferrules define leading edges, and wherein
the ferrules are designed so that these leading edges bite into the conduit during pull-up, or
the ferrules are designed to undergo plastic deformation during pull-up, or
both.

20. The method of claim 17, wherein a lubricant is applied to the surfaces of the fittings or components having oxide coatings of different colors thereon.

21. The method of claim 20, wherein the fittings or components having oxide coatings of different colors are ferrules.

22. The method of claim 21, wherein the stainless steel tube fittings are designed for joining to a conduit, wherein the ferrules define leading edges, and wherein
the ferrules are designed so that these leading edges bite into the conduit during pull-up, or
the ferrules are designed to undergo plastic deformation during pull-up, or
both.
